(19) United States
(12) Patent Application Publication
(10) Pub. No.: US 2008/0198837 A1
(43) Pub. Date: Aug. 21, 2008

(54) System and method for transmitting and receiving signal in communication system

(75) Inventors: June Moon, Seoul (KR); Sung-Woo Park, Suwon-si (KR); Yong-Seok Kim, Suwon-si (KR); Soon-Young Yoon, Seoul (KR); In-Seok Hwang, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/012,328

(22) Filed: Feb. 1, 2008

(30) Foreign Application Priority Data
Feb. 2, 2007 (KR) 2007-11146
Feb. 2, 2007 (KR) 2007-11148

(51) Int. Cl. H04J 3/06; H04J 3/00

(52) U.S. Cl. 370/350; 370/345

(57) ABSTRACT

Disclosed is a method for transmitting and receiving a signal in a communication system, and a system for supporting the method. To this end, a first communication system transmits data during a first time slot and receives data during a third time slot, and a second communication system, differing from the first communication system, transmits data during a second time slot and receives data during a fourth time slot. The first and second time slots are defined by downlink frame transmission intervals which exist in the entire frame transmission interval allocated for the first communication system, and the third and fourth time slots are defined by uplink frame transmission intervals which exist in the entire frame transmission interval allocated for the first communication system, wherein the first to fourth time slots do not overlap each other.

### CROSS-REFERENCE TO RELATED APPLICATION(S) AND CLAIM OF PRIORITY

The present application claims priority to application entitled “System And Method For Transmitting and Receiving Signal In Communication System” filed with the Korean Intellectual Property Office on Feb. 2, 2007 and assigned Serial No. 2007-11146, and filed Feb. 2, 2007 and assigned Serial No. 2007-11148, the contents of which are incorporated herein by reference.

### TECHNICAL FIELD OF THE INVENTION

The present invention relates to a communication system, and more particularly to a system and method for transmitting and receiving a signal in a communication system.

### BACKGROUND OF THE INVENTION

Presently, communication technologies are undergoing rapid development, and studies are actively progressing in the area of next generation communication systems employing new communication technologies. Accordingly, service transition from the conventional communication systems to next-generation communication systems is also actively progressing. However, until the communication service employing the next generation communication system becomes more stable and marketable, employing both the next generation communication system and the conventional communication system remains essential for complementary communication service.

For example, if the conventional communication system is the Code Division Multiple Access (CDMA) 1x system, and the next generation communication system is the CDMA Evolution-Data Only (CDMA EV-DO) system evolved from the CDMA 1x system, it is necessary to employ both the CDMA 2000 1x system and the CDMA EV-DO system for providing complementary communication service until the CDMA EV-DO system becomes more stable and marketable.

FIG. 1 is a view illustrating a typical frequency band distribution when the CDMA 1x system and the CDMA EV-DO system coexist with each other.

The CDMA 1x system and the CDMA EV-DO system use mutually different frequency bands. That is, the CDMA 1x system uses frequency resources of band #1 101, and the CDMA EV-DO system uses frequency resources of band #2 103. In FIG. 1, a CDMA 1x terminal 105 represents a terminal receiving service only from the CDMA 1x system, and a CDMA EV-DO terminal 109 represents a terminal receiving service only from the CDMA EV-DO system.

The CDMA 1x terminal 105 receives service through band #1 101, and the CDMA EV-DO terminal 109 receives service through band #2 103. In addition, a multi-mode terminal 107 represents a terminal desiring to receive service from both the CDMA 1x system and the CDMA EV-DO system. However, it is impossible for the multi-mode terminal 107 to receive service from the CDMA 1x system and the CDMA EV-DO system at the same time.

FIG. 2 is a view illustrating a frequency allocation structure when a communication system is operated in such a manner as to divide one cell into three sectors.

A frequency band is divided into three sectors 201, 203 and 205. When it is assumed that a frequency reuse ratio is “3,” it is possible to allocate one frequency band to each of the three sectors 201, 203 and 205.

However, since such a frequency band allocation scheme causes different frequency bands to be allocated according to each sector, it is necessary to develop a technological solution capable of operating the conventional communication system and the next generation communication system at the same time.

As described above, the conventional terminal supporting the conventional communication system and the next generation communication system cannot simultaneously receive service from the conventional communication system and the next generation communication system.

In addition, collision of frequency bands used by the conventional communication system and the next generation communication system degrades the efficiency of each system, thereby causing users to be dissatisfied with Quality of Service (QoS).

Therefore, it is urgent to develop a detailed solution which enables the multi-mode terminal to simultaneously receive service from the conventional communication system and the next generation communication system, and can satisfy service efficiency and QoS of each system.

### SUMMARY OF THE INVENTION

To address the above-discussed deficiencies of the prior art, it is a primary object to provide a system and method for enabling a terminal, which supports a plurality of communication systems employing mutually different communication schemes, to transmit and receive signals to and from the plurality of communication systems.

Also, the present invention provides a system and method for transmitting and receiving signals, which enable a plurality of communication systems employing mutually different communication schemes to simultaneously provide service to a multi-mode terminal.

Also, the present invention provides a system and method for transmitting and receiving signals, which can satisfy service efficiency and QoS of each of communication systems employing mutually different communication schemes.

Also, the present invention provides a base station system enabling the conventional communication system and the next generation communication system to be simultaneously used, and provides a system and method enabling efficient signal transmission and reception to be achieved through the base station system.

In addition, the present invention provides a system and method for transmitting and receiving signals, which cause different communication systems employing the same frequency band to use different time slot ranges within the same frequency band, thereby enabling the communication systems to operate at the same time.

In accordance with an aspect of the present invention, there is provided a method for transmitting and receiving a signal in a communication system, the method including the steps of: transmitting, by a first communication system, data during a first time slot, and receiving data during a third time slot; and transmitting, by a second communication system different from the first communication system, data during a second time slot, and receiving data during a fourth time slot, wherein the first and second time slots are defined by downlink frame transmission intervals which exist in an entire frame transmission interval allocated for the first communication system, the third and fourth time slots are defined by uplink frame transmission intervals which exist in the entire frame transmission interval allocated for the first communication system, and the first to fourth time slots do not overlap each other.

In accordance with another aspect of the present invention, there is provided a communication system including: a first communication system for transmitting data during a first time slot, and receiving data during a third time slot; and a second communication system for transmitting data during a second time slot, and receiving data during a fourth time slot, the second communication system differing from the first communication system, wherein the first and second time slots are defined by downlink frame transmission intervals which exist in an entire frame transmission interval allocated for the first communication system, the third and fourth time slots are defined by uplink frame transmission intervals which exist in the entire frame transmission interval allocated for the first communication system, and the first to fourth time slots do not overlap each other.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a typical frequency band distribution when the CDMA 1x system and the CDMA EV-DO system coexist with each other;

FIG. 2 is a view illustrating a frequency allocation structure when a communication system is operated in such a manner as to divide one cell into three sectors;

FIG. 3 is a view illustrating a frequency band distribution of a Loosely Backward Compatibility (LBC) communication system according to an exemplary embodiment of the present invention;

FIG. 4 is a view illustrating the configuration of a base station according to an exemplary embodiment of the present invention;

FIG. 5 is a view illustrating the configuration of an LBC terminal according to an exemplary embodiment of the present invention;

FIG. 6 is a flowchart schematically illustrating a procedure in which a terminal acquires a signal transmitted from a base station and analyzes a resource utilization according to an exemplary embodiment of the present invention;

FIG. 7 is a flowchart illustrating a procedure in which a base station acquires a resource utilization from a terminal according to an exemplary embodiment of the present invention; and

FIG. 8 is a view schematically illustrating a resource allocation structure in one frequency band according to an exemplary embodiment of the present invention.

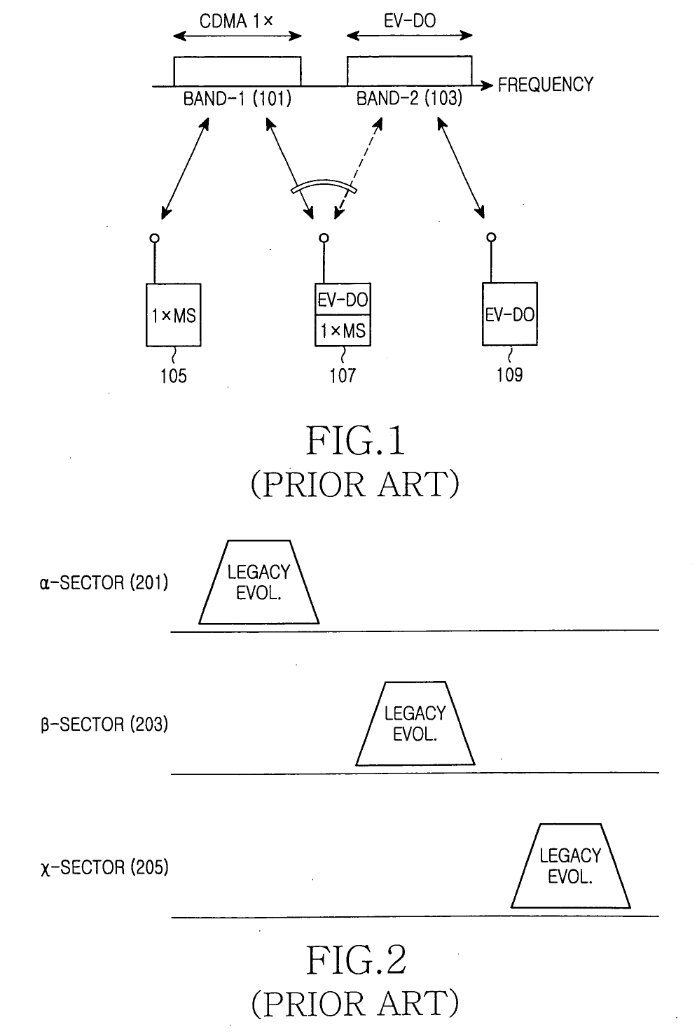

### DETAILED DESCRIPTION OF THE INVENTION

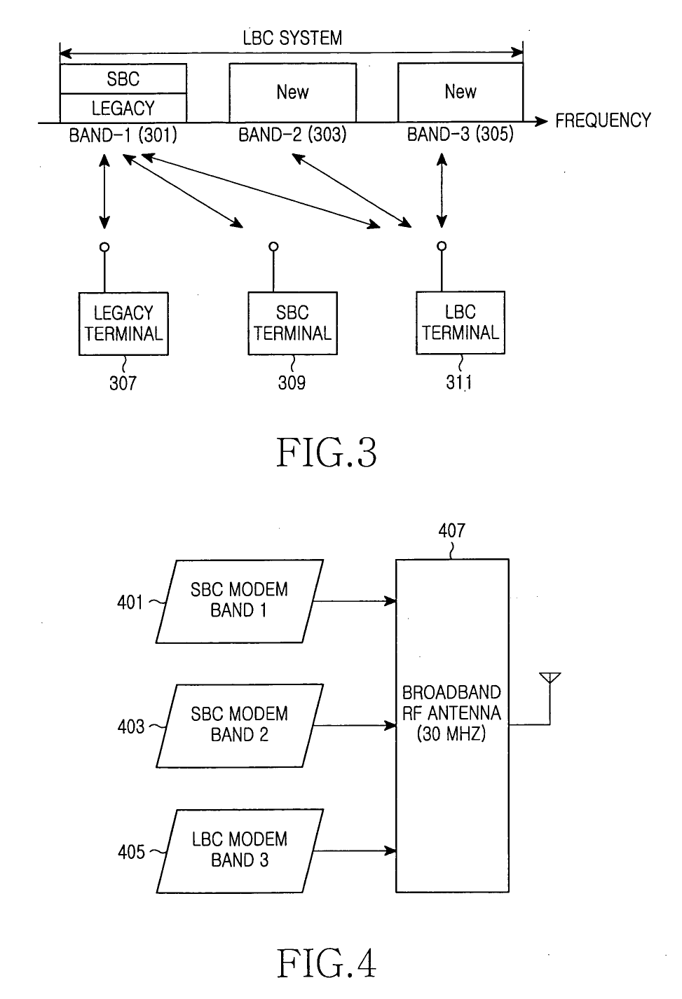

FIGS. 3 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication systems.

FIG. 3 is a view illustrating a frequency band distribution of a Loosely Backward Compatibility (LBC) communication system according to an exemplary embodiment of the present invention.

The LBC communication system in FIG. 3 uses band #1 301, which is a usable frequency band of both a Legacy communication system and a Strictly Backward Compatibility (SBC) communication system, the systems observing the existing standard, and band #2 303 and band #3 305, which are usable frequency bands of a new communication system.

Here, the Legacy communication system represents a communication system which provides service according to the Legacy scheme. The SBC communication system represents a communication system which provides service according to the SBC scheme, and provides service through the same frequency band as the Legacy communication system. The new communication system represents a communication system which provides service according to a new communication scheme, and provides service through frequency bands different from those of the Legacy communication system and the SBC communication system. The LBC communication system includes the Legacy communication system, the SBC communication system, and the new communication system.

In FIG. 3, a Legacy terminal 307 represents a terminal receiving service only from the Legacy communication system, an SBC terminal 309 represents a terminal receiving service only from the SBC communication system, and the LBC terminal 311 represents a terminal receiving service from the Legacy communication system, the SBC communication system, and the new communication system.

The Legacy terminal 307 and the SBC terminal 309 communicate using band #1 301. The LBC terminal 311 can communicate using all of band #1 301, band #2 303 and band #3 305. That is, the LBC terminal 311 can communicate using at least one of the three bands 301, 303 and 305.

As shown in FIG. 3, the usable frequency band of the LBC communication system includes band #1 301, which is the usable frequency band of the Legacy communication system and the SBC communication system, and includes band #2 303 and band #3 305, which are usable frequency bands of the new communication system, so that the Legacy terminal 307 and the SBC terminal 309 can communicate with the LBC terminal 311.

FIG. 4 is a view illustrating the configuration of a base station for supporting a communication system according to an exemplary embodiment of the present invention.

The base station includes three channel cards 401, 403 and 405, and a broadband radio frequency (RF) antenna 407.

Among the three channel cards, channel card #1 401 and channel card #2 403 support a Legacy system and an SBC system. Also, channel card #1 401 can transmit data up to a maximum of 10 MHz through band #1, and channel card #2 403 can transmit data up to a maximum of 10 MHz through band #2.

Meanwhile, channel card #3 405 supports the LBC communication system proposed by the present invention, and can transmit data up to a maximum of 10 MHz through band #3. Since channel card #3 405 can support the LBC system, channel card #3 405 can support transmission standards of both the Legacy system and the SBC system. Therefore, channel card #3 405 can transmit data, even through band #1 of channel card #1 401 and band #2 of channel card #2 403. In other words, channel card #3 405 can transmit data up to a maximum of 30 MHz through bands #1, #2 and #3.

However, since band #1 and band #2 are in operation by the Legacy and SBC systems, which are existing communication systems, channel card #3 405 cannot transmit data to the Legacy terminal at a maximum of 30 MHz without permission, together with channel card #1 401 and channel card #2 403.

Also, since channel card #1 401, channel card #2 403, and channel card #3 405 are separately configured as shown in FIG. 4, there is no way to exchange scheduling information between the channel cards. Therefore, it is necessary to perform a procedure for acquiring scheduling information between the channel cards. To this end, the present invention proposes the configuration of an LBC terminal by which scheduling information between channel cards can be acquired.

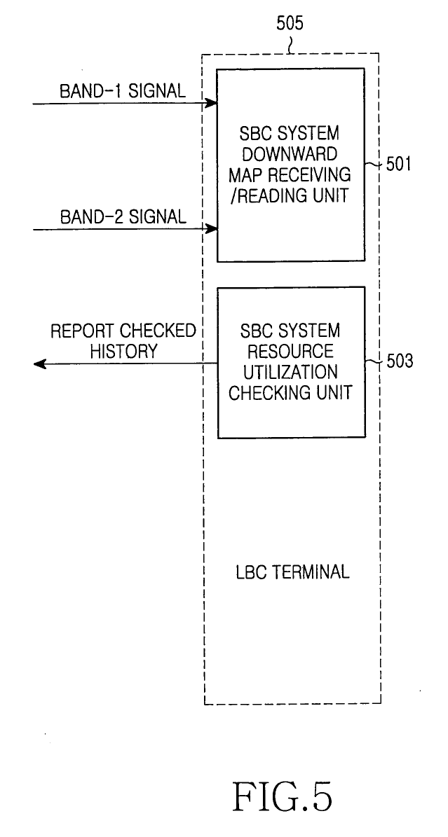

FIG. 5 is a view illustrating the configuration of an LBC terminal according to an exemplary embodiment of the present invention.

The LBC terminal 505 includes an SBC Communication System MAP receiving and reading unit 501 and an SBC Communication System resource utilization checking unit 503, wherein the SBC Communication System MAP receiving and reading unit 501 receives a signal transmitted through bands #1 and #2 from a base station, extracts a map, and reads the extracted map. The SBC Communication System resource utilization checking unit 503 estimates if resources of the extracted map have been utilized.

The SBC Communication System MAP receiving and reading unit 501 receives a signal transmitted from the base station through bands #1 and #2. The SBC Communication System MAP receiving and reading unit 501 extracts a downward map from the received signal, and provides the extracted downward map to the SBC Communication System resource utilization checking unit 503. The SBC Communication System resource utilization checking unit 503 checks a utilization situation of downlink (DL) resources by using the downward map, and creates resource utilization information about bands #1 and #2 based on a result of the checking. Then, the SBC Communication System resource utilization checking unit 503 reports the created resource utilization information about bands #1 and #2 to the base station.

Hereinafter, a procedure of transmitting and receiving scheduling information between a base station and an LBC terminal according to an exemplary embodiment of the present invention will be described.

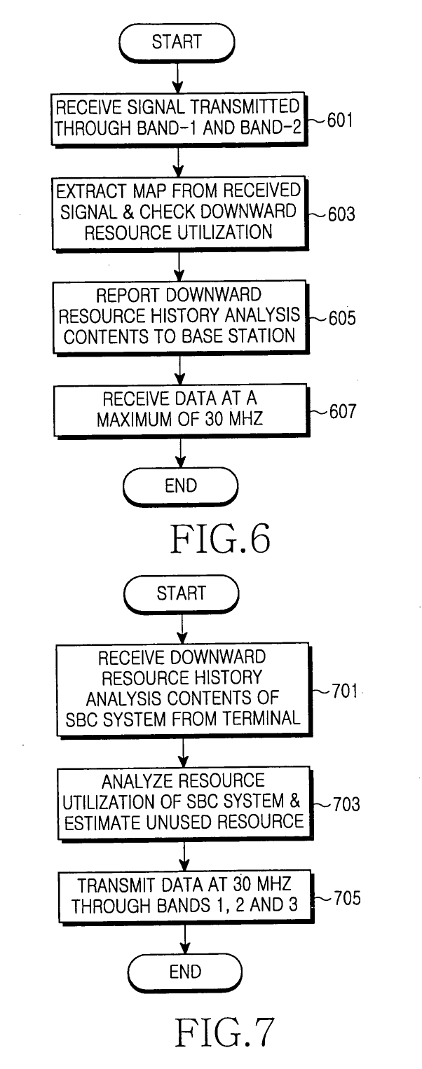

FIG. 6 is a flowchart schematically illustrating a procedure in which a terminal acquires a signal transmitted from a base station and analyzes a resource utilization according to an exemplary embodiment of the present invention.

In step 601, the terminal receives a signal transmitted from the base station through bands #1 and #2, and proceeds to step 603. In step 603, the terminal extracts a map from the received signal, checks a downward resource utilization by using the extracted map, creates resource utilization information by using a result of the checking, and then proceeds to step 605.

In step 605, the terminal transmits the resource utilization information about bands #1 and #2 to the base station, and proceeds to step 607. In step 607, the terminal receives data from the base station through bands #1 to #3. For example, when each of bands #1 to #3 corresponds to a frequency band of 10 MHz, the terminal can receive data through 30 MHz, which is the maximum frequency band.

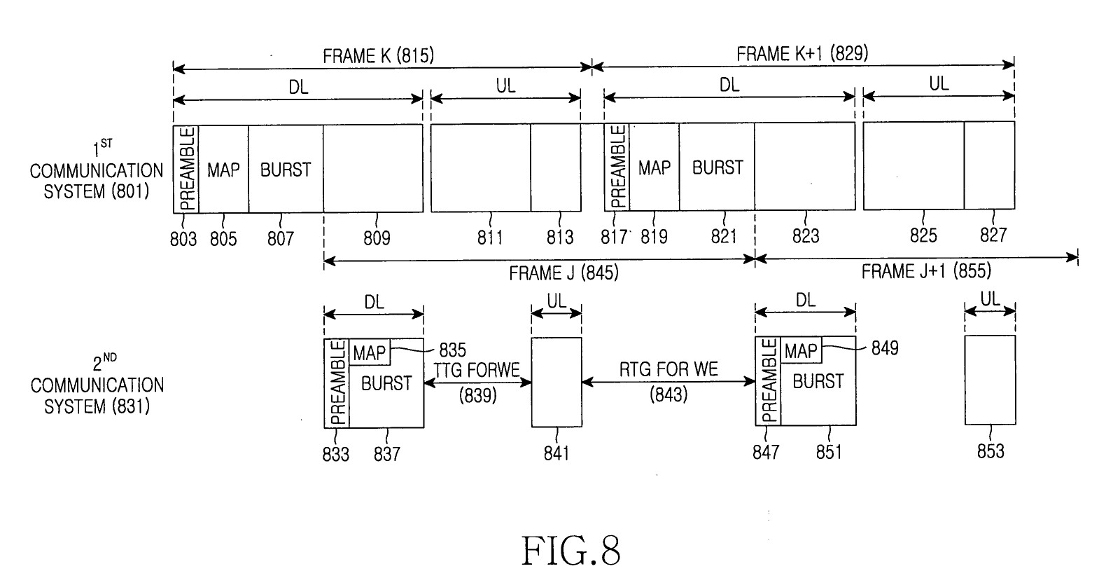

FIG. 7 is a flowchart illustrating a procedure in which a base station acquires resource utilization information from a terminal according to an exemplary embodiment of the present invention.

In step 701, the base station receives resource utilization information about bands #1 and #2 from the terminal, and proceeds to step 703. In step 703, the base station analyzes resource utilization of the SBC communication system by using the resource utilization information about bands #1 and #2, estimates unused resources, and then proceeds to step 705.

When the unused resources of bands #1 and #2 have been estimated, the base station transmits data through band #3, and the unused resources of bands #1 and #2 in step 705. For example, when each of bands #1 to #3 corresponds to a frequency band of 10 MHz, and both bands #1 and #2 have not been used, the base station can transmit data to the terminal through 30 MHz, which is the frequency band including bands #1 to #3.

Through the aforementioned procedure, in a plurality of communication systems providing service through mutually different frequency bands, the base station can provide data through the mutually different frequency bands at the same time, and the terminal can receive data through the mutually different frequency bands.

FIG. 8 is a view schematically illustrating a resource allocation structure in one frequency band according to an exemplary embodiment of the present invention.

In the following description, the present invention proposes a method of using predetermined frequency resources according to mutually different time slot ranges in a plurality of systems when the plurality of systems exist in one cell. Here, it is assumed that there are three sectors in one cell, and the three sectors are operated with a frequency reuse ratio of “3.”

First, the following principal features are defined.

(1) Legacy system: a system observing the conventional standard, which will be referred to as a first communication system. The first communication system uses the Legacy scheme, and provides communication service corresponding to the Legacy scheme.

(2) A terminal supporting only the Legacy system can communication regardless of presence or absence of an evolution system (hereinafter, referred to as a second communication system). The second communication system provides communication service corresponding to the second communication system.

(3) A terminal supporting the second communication system can communicate with both the first and second communication systems.

(4) A base station of the first communication system and a base station of the second communication system are synchronized with each other, and can cooperate with each other.

Referring to FIG. 8, resources within one frequency band are divided and allocated to a first communication system 801 and a second communication system 831.

Frames for the first communication system 801 include frame K 815 to frame K+1 829, and frames for the second communication system 831 include frame J 845 to frame J+1 855.

Frame K 815 for the first communication system 801 includes a preamble region 803, a MAP message region 805, downlink burst regions 807 and 809, and uplink burst regions 811 and 813. A time slot range to transmit the preamble region 803, the MAP message region 805, and the downlink burst region 807 is called a first time slot range, a time slot range to transmit the downlink burst region 809 is called a second time slot range, a time slot range to receive the uplink burst region 811 is called a third time slot range, and a time slot range to receive the uplink burst region 813 is called a fourth time slot range.

The preamble region 803 includes, for example, information required for a terminal to achieve synchronization with a base station and to measure a channel status. The MAP message region 805 includes a plurality of MAP information elements, that is, burst allocation information and so on. The downlink burst region 807 includes data to be transmitted to a specified terminal.

The downlink burst region 809 corresponds to a region to which data of the first communication system 801 is not allocated. The downlink burst region 809 is synchronized with the second communication system 831 in advance so as to support the second communication system 831, and is allocated as a downlink region of the second communication system 831 during the preset time slot range. That is, the downlink burst region 809 is allocated as a downlink resource region of frame J 845.

The uplink burst region 811 corresponds to a region to which uplink data of the first communication system 801 is allocated. The uplink burst region 813 corresponds to a region to which uplink data of the first communication system 801 is not allocated during a preset time slot range. The uplink burst region 813 is synchronized, in advance, so as to support the second communication system 831, and is allocated as an uplink resource region of the second communication system 831 during the preset time slot range. That is, the uplink burst region 813 is allocated as an uplink resource region of frame J 845.

Similar to the downlink resource region of frame K 815, the downlink resource region of frame J 845 includes a preamble region 833, a MAP message region 835, and a downlink burst region 837. The functions of each region included in the downlink resource region of frame J 845 are the same as those described above, so a description thereof will be omitted.

Also, similar to the uplink resource region of frame K 815, the uplink resource region of frame J 845 includes an uplink burst region 841. The function of the uplink burst region 841 is the same as that described above, so a description thereof will be omitted.

A region between the downlink resource region of frame J 845 and the uplink resource region of frame J 845 is called a Transmit and Receive Transition Gap (TTG) 839, a region between the uplink resource region of frame J 845 and the downlink resource region of frame J+1 855 is called a Receive and Transmit Transition Gap (RTG) 843.

Also, a ratio between a time slot range for the resource allocation region of the first communication system and a time slot range for the resource allocation region of the second communication system may be adjusted. That is, the ratio may be adjusted by adjusting the time slot regions according to the number of users using each system. For example, when there are more users of the first communication system than users of the second communication system, the resource allocation region of the first communication system is allocated a longer time slot range than the resource allocation region of the second communication system. In contrast, when there are less users of the first communication system than users of the second communication system, the resource allocation region of the second communication system may be allocated a longer time slot range than the resource allocation region of the first communication system. Also, adjustment for the time slot ranges is defined according to systems, which has no direct relation to the present invention, so a detailed description thereof will be omitted.

By the aforementioned method, when resources are allocated to two communication systems employing mutually different communication schemes in the same frequency band, it is possible to simultaneously use the two communication systems in the same frequency band. Also, when there is a multi-mode terminal receiving service from both the first and second communication systems, the multi-mode terminal can receive service from the first and second communication systems at the same time. For example, a downlink region is allocated to the first communication system, while an uplink region is allocated to the second communication system. Therefore, in this case, the multi-mode terminal can receive service from the first communication system through the downlink region while receiving service from the second communication system through the uplink region.

For example, while the present invention has been described about a case where the first and second communication systems have a frame structure of a Time Division Duplexing (TDD) scheme, the present invention can be also applied to a case where the first and second communication systems have a frame structure of a Frequency Division Duplexing (FDD) scheme.

According to the present invention, a plurality of communication systems employing mutually different communication schemes can transmit signals to a multi-mode terminal, thereby improving QoS, as well as service efficiency of each system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting and receiving a signal in a communication system, the method comprising the steps of:
transmitting, by a first communication system, data during a first time slot, and receiving data during a third time slot; and
transmitting, by a second communication system different from the first communication system, data during a second time slot, and receiving data during a fourth time slot,
wherein the first and second time slots are defined by downlink frame transmission intervals which exist in an entire frame transmission interval allocated for the first communication system, the third and fourth time slots are defined by uplink frame transmission intervals which exist in the entire frame transmission interval allocated for the first communication system, and the first to fourth time slots do not overlap each other.

2. The method as claimed in claim 1, wherein the first to fourth time slots do not overlap each other on a time axis.

3. The method as claimed in claim 1, wherein the first to third time slots do not overlap each other on a frequency axis.

4. The method as claimed in claim 1, wherein the data transmitted during the first time slot comprises a reference signal for acquiring synchronization of the first communication system, burst allocation information of the first communication system, and downlink burst data of the first communication system.

5. The method as claimed in claim 1, wherein the data received during the third time slot comprises uplink burst data of the first communication system.

6. The method as claimed in claim 1, wherein the data transmitted during the second time slot comprises a reference signal for acquiring synchronization of the second communication system, burst allocation information of the second communication system, and downlink burst data of the second communication system.

7. The method as claimed in claim 1, wherein the data received during the fourth time slot comprises uplink burst data of the second communication system.

8. The method as claimed in claim 1, wherein the lengths of the first and fourth time slots are changed in consideration of distribution of users between the first communication system and the second communication system.

9. A communication system comprising:
a first communication system for transmitting data during a first time slot, and receiving data during a third time slot; and
a second communication system for transmitting data during a second time slot, and receiving data during a fourth time slot, the second communication system differing from the first communication system,
wherein the first and second time slots are defined by downlink frame transmission intervals which exist in an entire frame transmission interval allocated for the first communication system, the third and fourth time slots are defined by uplink frame transmission intervals which exist in the entire frame transmission interval allocated for the first communication system, and the first to fourth time slots do not overlap each other.

10. The system as claimed in claim 9, wherein the first to fourth time slots do not overlap each other on a time axis.

11. The system as claimed in claim 9, wherein the first to third time slots do not overlap each other on a frequency axis.

12. The system as claimed in claim 9, wherein the data transmitted during the first time slot comprises a reference signal for acquiring synchronization of the first communication system, burst allocation information of the first communication system, and downlink burst data of the first communication system.

13. The system as claimed in claim 9, wherein the data received during the third time slot comprises uplink burst data of the first communication system.

14. The system as claimed in claim 9, wherein the data transmitted during the second time slot comprises a reference signal for acquiring synchronization of the second communication system, burst allocation information of the second communication system, and downlink burst data of the second communication system.

15. The system as claimed in claim 9, wherein the data received during the fourth time slot comprises uplink burst data of the second communication system.

16. The system as claimed in claim 9, wherein the lengths of the first and fourth time slots are changed in consideration of distribution of users between the first communication system and the second communication system.

17. The system as claimed in claim 9, wherein the first communication system is a legacy communication system.

18. The system as claimed in claim 9, wherein the second communication system is an evolution system.
